(19) United States
(12) Patent Application Publication
(10) Pub. No.: US 2025/0148571 A1
(43) Pub. Date: May 8, 2025

(54) FAST INFERENCING FOR HIGH-QUALITY SUPER-RESOLUTION OR OTHER IMAGE PROCESSING USING DIFFUSION MODELS

(71) Applicant: Samsung Electronics Co., Ltd., Suwon-si (KR)

(72) Inventors: Zhe Zhu, Irvine, CA (US); Tien Bau, Irvine, CA (US); Aditya Ghuge, Seattle, WA (US)

(21) Appl. No.: 18/737,450

(22) Filed: Jun. 7, 2024

Related U.S. Application Data
(60) Provisional application No. 63/597,062, filed on Nov. 8, 2023.

(51) Int. Cl. G06T 5/60; G06T 3/4053; G06T 5/50; G06T 5/70

(52) U.S. Cl. CPC G06T 5/60; G06T 3/4053; G06T 5/50; G06T 5/70; G06T 2207/20081; G06T 2207/20212

(57) ABSTRACT

A method includes obtaining, using at least one processing device of an electronic device, an input image. The method also includes up-scaling, using the at least one processing device, the input image to generate an up-sampled image. The method further includes degrading, using the at least one processing device, the up-sampled image to generate a degraded up-sampled image. The method also includes combining, using the at least one processing device, the up-sampled image and the degraded up-sampled image to generate combined data. In addition, the method includes generating, using the at least one processing device, an output image based on the combined data, where the output image is generated using a diffusion model.

### CROSS-REFERENCE TO RELATED APPLICATION AND PRIORITY CLAIM

This application claims priority under 35 U.S.C. § 119(e) to U.S. Provisional Patent Application No. 63/597,062 filed on Nov. 8, 2023. This provisional patent application is hereby incorporated by reference in its entirety.

### TECHNICAL FIELD

This disclosure relates generally to image processing systems and processes. More specifically, this disclosure relates to fast inferencing for high-quality super-resolution or other image processing using diffusion models.

### BACKGROUND

Modern televisions and other display devices are capable of displaying images at high resolution levels. For example, some current display devices are capable of displaying images at resolutions up to 8K (7,680 pixels by 4,320 pixels). It is expected that resolutions of display devices will continue to increase over time.

### SUMMARY

This disclosure relates to fast inferencing for high-quality super-resolution or other image processing using diffusion models.

In a first embodiment, a method includes obtaining, using at least one processing device of an electronic device, an input image. The method also includes up-scaling, using the at least one processing device, the input image to generate an up-sampled image. The method further includes degrading, using the at least one processing device, the up-sampled image to generate a degraded up-sampled image. The method also includes combining, using the at least one processing device, the up-sampled image and the degraded up-sampled image to generate combined data. In addition, the method includes generating, using the at least one processing device, an output image based on the combined data, where the output image is generated using a diffusion model.

In a second embodiment, an electronic device includes at least one processing device configured to obtain an input image, up-scale the input image to generate an up-sampled image, and degrade the up-sampled image to generate a degraded up-sampled image. The at least one processing device is also configured to combine the up-sampled image and the degraded up-sampled image to generate combined data and generate an output image based on the combined data. The at least one processing device is configured to generate the output image using a diffusion model.

In a third embodiment, a non-transitory machine readable medium contains instructions that when executed cause at least one processor of an electronic device to obtain an input image, up-scale the input image to generate an up-sampled image, and degrade the up-sampled image to generate a degraded up-sampled image. The non-transitory machine readable medium also contains instructions that when executed cause the at least one processor to combine the up-sampled image and the degraded up-sampled image to generate combined data and generate an output image based on the combined data. The instructions when executed cause the at least one processor to generate the output image using a diffusion model.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

As used here, terms and phrases such as “have,” “may have,” “include,” or “may include” a feature (like a number, function, operation, or component such as a part) indicate the existence of the feature and do not exclude the existence of other features. Also, as used here, the phrases “A or B,” “at least one of A and/or B,” or “one or more of A and/or B” may include all possible combinations of A and B. For example, “A or B,” “at least one of A and B,” and “at least one of A or B” may indicate all of (1) including at least one A, (2) including at least one B, or (3) including at least one A and at least one B. Further, as used here, the terms “first” and “second” may modify various components regardless of importance and do not limit the components. These terms are only used to distinguish one component from another. For example, a first user device and a second user device may indicate different user devices from each other, regardless of the order or importance of the devices. A first component may be denoted a second component and vice versa without departing from the scope of this disclosure.

It will be understood that, when an element (such as a first element) is referred to as being (operatively or communicatively) “coupled with/to” or “connected with/to” another element (such as a second element), it can be coupled or connected with/to the other element directly or via a third element. In contrast, it will be understood that, when an element (such as a first element) is referred to as being “directly coupled with/to” or “directly connected with/to” another element (such as a second element), no other element (such as a third element) intervenes between the element and the other element.

As used here, the phrase “configured (or set) to” may be interchangeably used with the phrases “suitable for,” “having the capacity to,” “designed to,” “adapted to,” “made to,” or “capable of” depending on the circumstances. The phrase “configured (or set) to” does not essentially mean “specifically designed in hardware to.” Rather, the phrase “configured to” may mean that a device can perform an operation together with another device or parts. For example, the phrase “processor configured (or set) to perform A, B, and C” may mean a generic-purpose processor (such as a CPU or application processor) that may perform the operations by executing one or more software programs stored in a memory device or a dedicated processor (such as an embedded processor) for performing the operations.

The terms and phrases as used here are provided merely to describe some embodiments of this disclosure but not to limit the scope of other embodiments of this disclosure. It is to be understood that the singular forms “a,” “an,” and “the” include plural references unless the context clearly dictates otherwise. All terms and phrases, including technical and scientific terms and phrases, used here have the same meanings as commonly understood by one of ordinary skill in the art to which the embodiments of this disclosure belong. It will be further understood that terms and phrases, such as those defined in commonly-used dictionaries, should be interpreted as having a meaning that is consistent with their meaning in the context of the relevant art and will not be interpreted in an idealized or overly formal sense unless expressly so defined here. In some cases, the terms and phrases defined here may be interpreted to exclude embodiments of this disclosure.

Examples of an “electronic device” according to embodiments of this disclosure may include at least one of a smartphone, a tablet personal computer (PC), a mobile phone, a video phone, an e-book reader, a desktop PC, a laptop computer, a netbook computer, a workstation, a personal digital assistant (PDA), a portable multimedia player (PMP), an MP3 player, a mobile medical device, a camera, or a wearable device (such as smart glasses, a head-mounted device (HMD), electronic clothes, an electronic bracelet, an electronic necklace, an electronic accessory, an electronic tattoo, a smart mirror, or a smart watch). Other examples of an electronic device include a smart home appliance. Examples of the smart home appliance may include at least one of a television, a digital video disc (DVD) player, an audio player, a refrigerator, an air conditioner, a cleaner, an oven, a microwave oven, a washer, a dryer, an air cleaner, a set-top box, a home automation control panel, a security control panel, a TV box (such as SAMSUNG HOMESYNC, APPLETV, or GOOGLE TV), a smart speaker or speaker with an integrated digital assistant (such as SAMSUNG GALAXY HOME, APPLE HOMEPOD, or AMAZON ECHO), a gaming console (such as an XBOX, PLAYSTATION, or NINTENDO), an electronic dictionary, an electronic key, a camcorder, or an electronic picture frame. Still other examples of an electronic device include at least one of various medical devices (such as diverse portable medical measuring devices (like a blood sugar measuring device, a heartbeat measuring device, or a body temperature measuring device), a magnetic resource angiography (MRA) device, a magnetic resource imaging (MRI) device, a computed tomography (CT) device, an imaging device, or an ultrasonic device), a navigation device, a global positioning system (GPS) receiver, an event data recorder (EDR), a flight data recorder (FDR), an automotive infotainment device, a sailing electronic device (such as a sailing navigation device or a gyro compass), avionics, security devices, vehicular head units, industrial or home robots, automatic teller machines (ATMs), point of sales (POS) devices, or Internet of Things (IoT) devices (such as a bulb, various sensors, electric or gas meter, sprinkler, fire alarm, thermostat, street light, toaster, fitness equipment, hot water tank, heater, or boiler). Other examples of an electronic device include at least one part of a piece of furniture or building/structure, an electronic board, an electronic signature receiving device, a projector, or various measurement devices (such as devices for measuring water, electricity, gas, or electromagnetic waves). Note that, according to various embodiments of this disclosure, an electronic device may be one or a combination of the above-listed devices. According to some embodiments of this disclosure, the electronic device may be a flexible electronic device. The electronic device disclosed here is not limited to the above-listed devices and may include any other electronic devices now known or later developed.

In the following description, electronic devices are described with reference to the accompanying drawings, according to various embodiments of this disclosure. As used here, the term “user” may denote a human or another device (such as an artificial intelligent electronic device) using the electronic device.

Definitions for other certain words and phrases may be provided throughout this patent document. Those of ordinary skill in the art should understand that in many if not most instances, such definitions apply to prior as well as future uses of such defined words and phrases.

None of the description in this application should be read as implying that any particular element, step, or function is an essential element that must be included in the claim scope. The scope of patented subject matter is defined only by the claims. Moreover, none of the claims is intended to invoke 35 U.S.C. § 112(f) unless the exact words “means for” are followed by a participle. Use of any other term, including without limitation “mechanism,” “module,” “device,” “unit,” “component,” “element,” “member,” “apparatus,” “machine,” “system,” “processor,” or “controller,” within a claim is understood by the Applicant to refer to structures known to those skilled in the relevant art and is not intended to invoke 35 U.S.C. § 112(f).

### BRIEF DESCRIPTION OF THE DRAWINGS

For a more complete understanding of this disclosure and its advantages, reference is now made to the following description taken in conjunction with the accompanying drawings, in which:

FIG. 1 illustrates an example network configuration including an electronic device in accordance with this disclosure;

FIGS. 2 and 3 illustrate example forward and reverse diffusion processes in accordance with this disclosure;

FIG. 4 illustrates an example architecture supporting fast inferencing for high-quality super-resolution or other image processing using a diffusion model in accordance with this disclosure; and

FIG. 5 illustrates an example method for fast inferencing for high-quality super-resolution or other image processing using a diffusion model in accordance with this disclosure.

### DETAILED DESCRIPTION

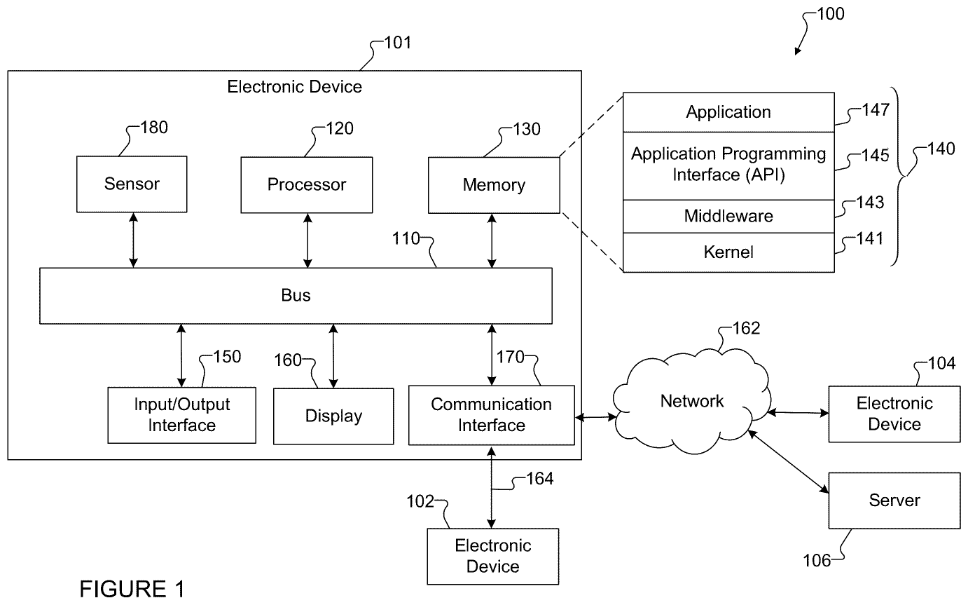

FIGS. 1 through 5, discussed below, and the various embodiments of this disclosure are described with reference to the accompanying drawings. However, it should be appreciated that this disclosure is not limited to these embodiments, and all changes and/or equivalents or replacements thereto also belong to the scope of this disclosure. The same or similar reference denotations may be used to refer to the same or similar elements throughout the specification and the drawings.

As noted above, modern televisions and other display devices are capable of displaying images at high resolution levels. For example, some current display devices are capable of displaying images at resolutions up to 8K (7,680 pixels by 4,320 pixels). It is expected that resolutions of display devices will continue to increase over time. With improvements in display devices, the demand for high-quality images and videos with higher resolutions has also increased. Unfortunately, in many cases, content that is available for viewing has a resolution that is less than the resolution of the display device on which the content is viewed, which can result in poor user experiences.

To help resolve this, various types of machine learning models have been proposed for increasing the resolution of image data, which is often referred to as super-resolution. Two examples of machine learning models used for super-resolution are generative adversarial networks (GANs) and diffusion models. While diffusion models can provide superior results than generative adversarial networks, diffusion models can suffer from various shortcomings when used in super-resolution applications. For example, the processing of an image using a diffusion model (referred to as an “inferencing” process) can be quite slow compared to generative adversarial networks. To achieve high-fidelity results using a diffusion model, for instance, it may be necessary to run the diffusion model thousands of times, which is impractical for real-time and other scenarios. Even with high-end graphics processing units (GPUs), running a neural network with billions of parameters thousands of times can require several minutes. Also, training a diffusion model used for super-resolution tends to be time-consuming and is a resource-intensive and dataset-intensive task. In addition, the effectiveness of the training can depend heavily on the actual architecture of the diffusion model to converge, and there are instances in which diffusion models converge to local optima (rather than global optima) during training. As a result, it is possible to see visible color and hue shifts in generated images, or the image quality of the generated images can otherwise be suboptimal.

This disclosure provides various techniques supporting fast inferencing for high-quality super-resolution or other image processing using diffusion models. As described in more detail below, an input image can be obtained, such as by using a camera or by receiving the image over a network. The input image can be up-scaled in order to generate an up-sampled image, such as by increasing the resolution of the input image via interpolation or other suitable technique. The up-sampled image can be degraded in order to generate a degraded up-sampled image, such as by applying a forward diffusion process to the up-sampled image. The forward diffusion process may typically be capable of converting an image into substantially pure noise if at least a specified number of iterations are performed, and applying the forward diffusion process to the up-sampled image may include performing less than the specified number of iterations in order to degrade the up-sampled image without converting the up-sampled image into substantially pure noise. In some cases, the up-sampled image may be degraded by performing 75% to 95% of the specified number of iterations. The up-sampled image and the degraded up-sampled image can be combined, such as via concatenation or addition, to generate combined data (such as a combined image, a concatenated image, etc.). The combined data can be provided to a diffusion model, which can generate an output image based on the combined data. In some cases, the output image may represent a super-resolution version of the input image.

In this way, the described techniques can significantly speed up inferencing operations performed using a diffusion model. In typical approaches, an image is combined with random Gaussian noise, and the resulting image data is provided to a diffusion model. While this is effective, it can require an excessively-long period of time to perform all of the iterations needed to produce a cleaner output image, and the cleaner output image may still contain noise, color or hue shifts, or other issues. In contrast, the described techniques can apply the forward diffusion process to the up-sampled image and utilize the resulting degraded up-sampled image (rather than using pure Gaussian noise), which can result in output images having higher quality. Moreover, the degree of degradation can be easily controlled by controlling the number of iterations performed during the forward diffusion process. The degraded up-sampled image still contains a significant amount of noise that enables the diffusion model to operate, but the degraded up-sampled image is not pure noise. This allows the degraded up-sampled image to provide a better starting point for the diffusion model to de-noise the up-sampled image, and it helps the diffusion model to generate a cleaner image since the degraded up-sampled image provides useful information to the diffusion model. As a result, the diffusion model can generate super-resolution output images or other output images faster and with more stable results (such as with little or no color-shifting).

Note that there are various applications and use cases in which this functionality may be used. For example, televisions or other displays, set-top boxes, TV boxes, or other devices may use this functionality in order to increase the resolution of images to be displayed to viewers. This may be useful, for instance, when presenting existing movies or other content having lower resolution (meaning content having a lower resolution than a display device on which the content is presented). As another example, televisions or other displays, smartphones, or other devices may use this functionality in order to increase the resolution of images or videos captured using smartphone cameras or other cameras. As yet another example, content providers may use this functionality to increase the resolution of content to be provided to users, and the processed content may be stored, streamed, or otherwise used. In general, this disclosure is not limited to any particular applications and use cases for the disclosed techniques. Also note that this functionality may be deployed in any suitable manner, such as when deployed as a trained machine learning model or other logic on an end user device (such as a smartphone, tablet computer, laptop computer, or other device) or when implemented by a server or in a cloud computing environment. In general, this disclosure is not limited to any particular deployment of the described functionality.

FIG. 1 illustrates an example network configuration 100 including an electronic device in accordance with this disclosure. The embodiment of the network configuration 100 shown in FIG. 1 is for illustration only. Other embodiments of the network configuration 100 could be used without departing from the scope of this disclosure.

According to embodiments of this disclosure, an electronic device 101 is included in the network configuration 100. The electronic device 101 can include at least one of a bus 110, a processor 120, a memory 130, an input/output (I/O) interface 150, a display 160, a communication interface 170, and a sensor 180. In some embodiments, the electronic device 101 may exclude at least one of these components or may add at least one other component. The bus 110 includes a circuit for connecting the components 120-180 with one another and for transferring communications (such as control messages and/or data) between the components.

The processor 120 includes one or more processing devices, such as one or more microprocessors, microcontrollers, digital signal processors (DSPs), application specific integrated circuits (ASICs), or field programmable gate arrays (FPGAs). In some embodiments, the processor 120 includes one or more of a central processing unit (CPU), an application processor (AP), a communication processor (CP), a graphics processor unit (GPU), or a neural processing unit (NPU). The processor 120 is able to perform control on at least one of the other components of the electronic device 101 and/or perform an operation or data processing relating to communication or other functions. As described below, the processor 120 may perform one or more functions related to fast inferencing for high-quality super-resolution or other image processing using a diffusion model.

The memory 130 can include a volatile and/or non-volatile memory. For example, the memory 130 can store commands or data related to at least one other component of the electronic device 101. According to embodiments of this disclosure, the memory 130 can store software and/or a program 140. The program 140 includes, for example, a kernel 141, middleware 143, an application programming interface (API) 145, and/or an application program (or “application”) 147. At least a portion of the kernel 141, middleware 143, or API 145 may be denoted an operating system (OS).

The kernel 141 can control or manage system resources (such as the bus 110, processor 120, or memory 130) used to perform operations or functions implemented in other programs (such as the middleware 143, API 145, or application 147). The kernel 141 provides an interface that allows the middleware 143, the API 145, or the application 147 to access the individual components of the electronic device 101 to control or manage the system resources. The application 147 may include one or more applications that, among other things, perform fast inferencing for high-quality super-resolution or other image processing using a diffusion model. These functions can be performed by a single application or by multiple applications that each carries out one or more of these functions. The middleware 143 can function as a relay to allow the API 145 or the application 147 to communicate data with the kernel 141, for instance. A plurality of applications 147 can be provided. The middleware 143 is able to control work requests received from the applications 147, such as by allocating the priority of using the system resources of the electronic device 101 (like the bus 110, the processor 120, or the memory 130) to at least one of the plurality of applications 147. The API 145 is an interface allowing the application 147 to control functions provided from the kernel 141 or the middleware 143. For example, the API 145 includes at least one interface or function (such as a command) for filing control, window control, image processing, or text control.

The I/O interface 150 serves as an interface that can, for example, transfer commands or data input from a user or other external devices to other component(s) of the electronic device 101. The I/O interface 150 can also output commands or data received from other component(s) of the electronic device 101 to the user or the other external device.

The display 160 includes, for example, a liquid crystal display (LCD), a light emitting diode (LED) display, an organic light emitting diode (OLED) display, a quantum-dot light emitting diode (QLED) display, a microelectromechanical systems (MEMS) display, or an electronic paper display. The display 160 can also be a depth-aware display, such as a multi-focal display. The display 160 is able to display, for example, various contents (such as text, images, videos, icons, or symbols) to the user. The display 160 can include a touchscreen and may receive, for example, a touch, gesture, proximity, or hovering input using an electronic pen or a body portion of the user. Note that in other embodiments, the display 160 may be external to the electronic device 101.

The communication interface 170, for example, is able to set up communication between the electronic device 101 and an external electronic device (such as a first electronic device 102, a second electronic device 104, or a server 106). For example, the communication interface 170 can be connected with a network 162 or 164 through wireless or wired communication to communicate with the external electronic device. The communication interface 170 can be a wired or wireless transceiver or any other component for transmitting and receiving signals.

The wireless communication is able to use at least one of, for example, WiFi, long term evolution (LTE), long term evolution-advanced (LTE-A), 5th generation wireless system (5G), millimeter-wave or 60 GHz wireless communication, Wireless USB, code division multiple access (CDMA), wideband code division multiple access (WCDMA), universal mobile telecommunication system (UMTS), wireless broadband (WiBro), or global system for mobile communication (GSM), as a communication protocol. The wired connection can include, for example, at least one of a universal serial bus (USB), high definition multimedia interface (HDMI), recommended standard 232 (RS-232), or plain old telephone service (POTS). The network 162 or 164 includes at least one communication network, such as a computer network (like a local area network (LAN) or wide area network (WAN)), Internet, or a telephone network.

The electronic device 101 may include one or more sensors 180 that can meter a physical quantity or detect an activation state of the electronic device 101 and convert metered or detected information into an electrical signal. For example, the sensor(s) 180 may include one or more cameras or other imaging sensors, which may be used to capture images of scenes. The sensor(s) 180 may also include one or more buttons for touch input, one or more microphones, a depth sensor, a gesture sensor, a gyroscope or gyro sensor, an air pressure sensor, a magnetic sensor or magnetometer, an acceleration sensor or accelerometer, a grip sensor, a proximity sensor, a color sensor (such as a red green blue (RGB) sensor), a bio-physical sensor, a temperature sensor, a humidity sensor, an illumination sensor, an ultraviolet (UV) sensor, an electromyography (EMG) sensor, an electroencephalogram (EEG) sensor, an electrocardiogram (ECG) sensor, an infrared (IR) sensor, an ultrasound sensor, an iris sensor, or a fingerprint sensor. Moreover, the sensor(s) 180 may include one or more position sensors, such as an inertial measurement unit that can include one or more accelerometers, gyroscopes, and other components. In addition, the sensor(s) 180 may include a control circuit for controlling at least one of the sensors included here. Any of these sensor(s) 180 can be located within the electronic device 101.

In some embodiments, the electronic device 101 can be a wearable device or an electronic device-mountable wearable device (such as an HMD). For example, the electronic device 101 may represent an XR wearable device, such as a headset or smart eyeglasses. In other embodiments, the first external electronic device 102 or the second external electronic device 104 can be a wearable device or an electronic device-mountable wearable device (such as an HMD). In those other embodiments, when the electronic device 101 is mounted in the electronic device 102 (such as the HMD), the electronic device 101 can communicate with the electronic device 102 through the communication interface 170. The electronic device 101 can be directly connected with the electronic device 102 to communicate with the electronic device 102 without involving with a separate network. In still other embodiments, the electronic device 101 can be a fixed or portable display device (such as a television) or an electronic device used in conjunction with a display device (such as a set-top box or TV box).

The first and second external electronic devices 102 and 104 and the server 106 each can be a device of the same or a different type from the electronic device 101. According to certain embodiments of this disclosure, the server 106 includes a group of one or more servers. Also, according to certain embodiments of this disclosure, all or some of the operations executed on the electronic device 101 can be executed on another or multiple other electronic devices (such as the electronic devices 102 and 104 or server 106). Further, according to certain embodiments of this disclosure, when the electronic device 101 should perform some function or service automatically or at a request, the electronic device 101, instead of executing the function or service on its own or additionally, can request another device (such as electronic devices 102 and 104 or server 106) to perform at least some functions associated therewith. The other electronic device (such as electronic devices 102 and 104 or server 106) is able to execute the requested functions or additional functions and transfer a result of the execution to the electronic device 101. The electronic device 101 can provide a requested function or service by processing the received result as it is or additionally. To that end, a cloud computing, distributed computing, or client-server computing technique may be used, for example. While FIG. 1 shows that the electronic device 101 includes the communication interface 170 to communicate with the external electronic device 104 or server 106 via the network 162 or 164, the electronic device 101 may be independently operated without a separate communication function according to some embodiments of this disclosure.

The server 106 can include the same or similar components as the electronic device 101 (or a suitable subset thereof). The server 106 can support to drive the electronic device 101 by performing at least one of operations (or functions) implemented on the electronic device 101. For example, the server 106 can include a processing module or processor that may support the processor 120 implemented in the electronic device 101. As described below, the server 106 may perform one or more functions related to fast inferencing for high-quality super-resolution or other image processing using a diffusion model.

Although FIG. 1 illustrates one example of a network configuration 100 including an electronic device 101, various changes may be made to FIG. 1. For example, the network configuration 100 could include any number of each component in any suitable arrangement. In general, computing and communication systems come in a wide variety of configurations, and FIG. 1 does not limit the scope of this disclosure to any particular configuration. Also, while FIG. 1 illustrates one operational environment in which various features disclosed in this patent document can be used, these features could be used in any other suitable system.

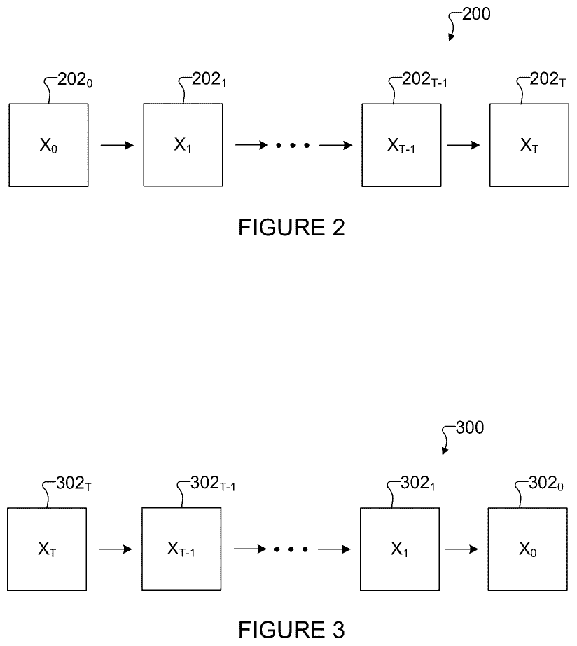

FIGS. 2 and 3 illustrate example forward and reverse diffusion processes 200 and 300 in accordance with this disclosure. As shown in FIG. 2, during the forward diffusion process 200, an input image 202₀ (also denoted X₀) is obtained and processed. More specifically, a small amount of Gaussian noise or other noise is iteratively added during each of T steps, resulting in the generation of T images 202₁-202_{T} (also denoted X₁-X_{T}). Each image in the sequence contains more noise than the preceding image in the sequence. The amount of noise added in each step can be controlled by a variance schedule, which can be expressed as {βₜ∈(0,1)}ₜ₌₁^{T}. The overall operation of the forward diffusion process 200 may be expressed as follows.

$$q ( {X}_{t} \vert {X}_{t - 1} ) = N ( {X}_{t} ; \sqrt{1 - {β}_{t}} {X}_{t - 1} , {β}_{t} I ) \\ q ( {X}_{1 : T} \vert {X}_{0} ) = {\prod }_{t = 1}^{T} q ( {X}_{t} \vert {X}_{t - 1} )$$

After a specified number of iterations (the T steps), the resulting image 202_{T} contains substantially pure noise, such as substantially only Gaussian noise.

As shown in FIG. 3, during the reverse diffusion process 300, an input image 302_{T} is obtained and processed. More specifically, the input image 302_{T} is a random noisy image, such as a random Gaussian image. The reverse diffusion process 300 operates to de-noise the input image 302_{T} during each of T steps, resulting in the generation of T images 302_{T-1}-302₀. Each image in the sequence contains less noise than the preceding image in the sequence. The removal of the noise is generally governed by two parameters, namely a mean (parameterized by μ_{θ}) and a variance (parameterized by Σ_{θ}). The overall operation of the reverse diffusion process 300 may be expressed as follows.

$${p}_{θ} = N ( {X}_{t - 1} ; {μ}_{θ} ( {X}_{t} , t ) , ) {\sum }_{θ} ( {X}_{t} , t ) \\ {p}_{θ} ( {X}_{0 : T} ) = p ( {X}_{T} ) {\prod }_{t = 1}^{T} {p}_{θ} ( {X}_{T - 1} \vert {X}_{T} )$$

After a specified number of iterations (the T steps), the resulting image 302₀ ideally contains little or no noise.

The forward diffusion process 200 and the reverse diffusion process 300 may be used during training of a diffusion model and inferencing by the diffusion model, respectively. During training, the forward diffusion process 200 can be used so that the diffusion model learns how original (clean) images can become noisier and noisier. Once trained, the diffusion model can be provided with noise, and the diffusion model repeatedly iterates to generate less-noisy images based on the original noise. For each iteration during the inferencing, the diffusion model estimates how a less-noisy image could be generated based on either the original noise (during the first iteration) or an image from the prior iteration (during each subsequent iteration). Ideally, each iteration of the inferencing produces a less-noisy image until a final noise-free image is obtained.

While this use of a diffusion model is effective for image synthesis, it is generally less suitable for use during image super-resolution. In other words, when the purpose of the diffusion model is to take a lower-resolution image and generate a higher-resolution version of the same image, the diffusion model can suffer from various shortcomings. For example, the diffusion model could be given a noisy image and pure Gaussian noise, and the diffusion model could perform inferencing in order to remove noise from the noisy image. Unfortunately, this approach assumes that all iterations of the reverse diffusion process 300 need to be performed, which can be very slow. Moreover, the results are not necessarily stable and can suffer from color and hue shifts or other artifacts. As described in more detail below, an architecture is provided that can help to reduce or eliminate these issues.

Although FIGS. 2 and 3 illustrate examples of forward and reverse diffusion processes 200 and 300, various changes may be made to FIGS. 2 and 3. For example, each of the forward and reverse diffusion processes 200 and 300 may include any suitable number of iterations.

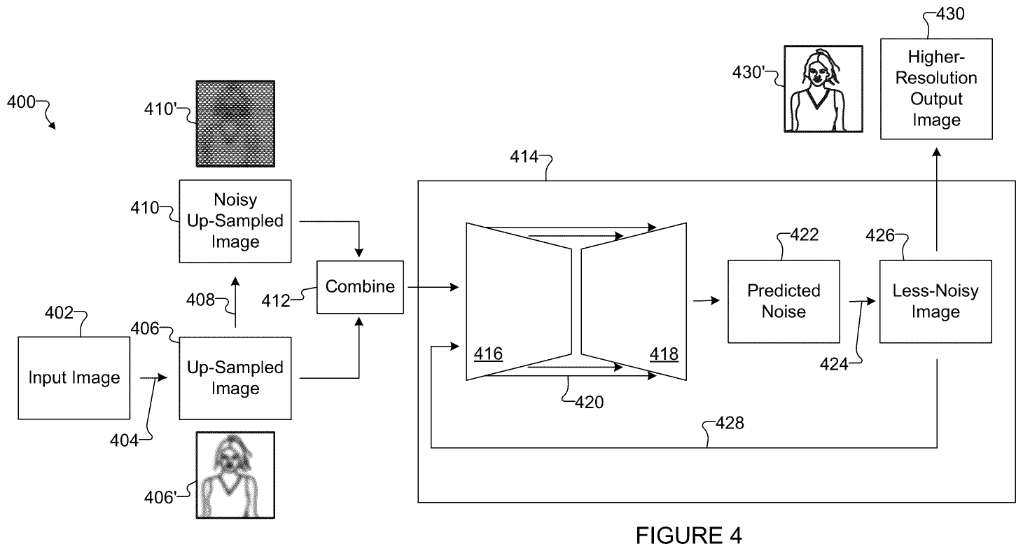

FIG. 4 illustrates an example architecture 400 supporting fast inferencing for high-quality super-resolution or other image processing using a diffusion model in accordance with this disclosure. For ease of explanation, the architecture 400 of FIG. 4 is described as being implemented using the electronic device 101 in the network configuration 100 of FIG. 1. However, the architecture 400 may be implemented using any other suitable device(s), such as the server 106, and in any other suitable system(s).

As shown in FIG. 4, the architecture 400 generally operates to receive input images 402 and generate higher-resolution output images 430, which represent higher-resolution versions of the input images 402. The input images 402 may be obtained from any suitable source(s). As examples, the input images 402 may be captured using at least one camera or other imaging sensor 180 of the electronic device 101 or obtained over the Internet or other network via at least one communication interface 170 of the electronic device 101. Any suitable number of input images 402 may be obtained here, and the input images 402 may represent individual images or images contained in a stream of images (such as a video sequence). Each input image 402 can have any suitable format, such as a red-green-blue (RGB) image format, a luma-chroma (YUV) image format, or a Bayer or other raw image format. Each input image 402 can also have any suitable resolution. In some cases, each input image 402 can have a resolution that is lower than desired. Each output image 430 can also have any suitable format and any suitable resolution, where each output image 430 generally has a higher resolution than its corresponding input image 402.

Each input image 402 is provided to and processed using an up-scaling function 404, which generally operates to convert the input image 402 into an associated up-sampled image 406. Each up-sampled image 406 has more pixels and therefore a higher resolution than its corresponding input image 402. However, the up-scaling process can introduce noise into the up-sampled image 406. The specific amount of up-scaling here can depend on various factors, such as the actual resolution of each input image 402 and the desired resolution of the corresponding output image 430. In some cases, for instance, the desired resolution of each output image 430 may match the resolution of a display device to present the output image 430. The up-scaling function 404 can use any suitable technique to increase the amount of image data contained in input images 202, such as bilinear or bicubic up-sampling.

A degradation function 408 generally operates to degrade each up-sampled image 406 and generate a corresponding noisy (degraded) up-sampled image 410. Each noisy up-sampled image 410 represents a version of the corresponding up-sampled image 406 with a significant amount of noise added to the up-sampled image 406. For example, the degradation function 408 can apply the forward diffusion process 200 to each up-sampled image 406 in order to generate the corresponding noisy up-sampled image 410. However, the degradation function 408 does not perform all iterations (all T steps) of the forward diffusion process 200 to each up-sampled image 406 in order to generate the corresponding noisy up-sampled image 410. Rather, the degradation function 408 performs less than all T steps so that each resulting noisy up-sampled image 410 contains substantial noise but is not pure noise. In some embodiments, the degradation function 408 may perform between 75% and 95% of the number of iterations needed in the forward diffusion process 200 to convert an image into substantially pure noise. The resulting noisy up-sampled images 410 therefore still contain some image data from the associated up-sampled images 406.

A combination function 412 generally operates to combine each up-sampled image 406 and its corresponding noisy up-sampled image 410 for input to a diffusion model 414. The combination function 412 may use any suitable technique to combine the image data of an up-sampled image 406 and the image data of its associated noisy up-sampled image 410. In some embodiments, for instance, the combination function 412 may concatenate the image data of an up-sampled image 406 and the image data of its associated noisy up-sampled image 410. In other embodiments, the combination function 412 may add the image data of an up-sampled image 406 and the image data of its associated noisy up-sampled image 410, such as via a pixel-wise addition.

The diffusion model 414 generally operates to process the up-sampled images 406 and the combination of the up-sampled images 406 and their corresponding noisy up-sampled images 410 in order to generate the higher-resolution output images 430. The diffusion model 414 represents a machine learning model that has been trained to identify and remove noise from images. Here, since the up-sampled images 406 have higher resolution than the original input images 402, the resulting output images 430 represent higher-resolution versions of the input images 402. In other words, the diffusion model 414 here is being used to process higher-resolution versions of the input images 402 (the up-sampled images 406) in order to remove noise from the higher-resolution versions of the input images 402, thereby supporting super-resolution.

In this example, the diffusion model 414 includes an encoder 416, a decoder 418, and skip connections 420 between the encoder 416 and the decoder 418. In some embodiments, these components may form a “U-net” architecture based on the logical arrangement of the components within the encoder 416 and the decoder 418. The encoder 416 can be implemented using a convolutional network that includes multiple levels. Each of at least some levels of the convolutional network may include one or more convolutional layers, one or more rectified linear unit (ReLU) or other activation layers, and one or more max pooling or other pooling layers. The convolutional network generally operates to convert image data into features, where the levels of the convolutional network generate features in progressively fewer channels having progressively larger depths. Effectively, the encoder 416 captures contextual information within the image data while reducing the spatial dimensions of the data.

The decoder 418 can be implemented using a deconvolutional network that includes multiple levels. Each of at least some levels of the deconvolutional network may include one or more up-sampling layers and one or more deconvolutional layers. The deconvolutional network generally operates to convert the encoded features generated by the encoder 416 back into image data, where the levels of the deconvolutional network expand the features into progressively larger spatial dimensions at progressively smaller depths. Effectively, the decoder 418 can convert encoded features of image data back into image data. The skip connections 420 allow features generated at different levels of the encoder 416 to be provided to levels at the same resolution in the decoder 418.

As part of the operation of the diffusion model 414, predicted noise 422 is generated, which represents a prediction of the amount of noise contained in the up-sampled image 406. Through the use of a noise scheduler 424, a portion of the predicted noise 422 is removed from the image data of the up-sampled image 406, resulting in the generation of a less-noisy image 426. As shown in this example, the encoder 416 and the decoder 418 are used repeatedly as part of an iterative process. During this iterative process, the less-noisy image 426 can be provided as feedback 428, where the less-noisy image 426 is input to the encoder 416 (in place of the original up-sampled image 406). The next iteration can occur, leading to the generation of predicted noise 422 contained in the less-noisy image 426. This results in the generation of the next less-noisy image 426, which can be provided as feedback 428 and input to the encoder 416 (in place of the previous less-noisy image 426). This can be repeated any number of times until the less-noisy image 426 that is generated is output as a higher-resolution output image 430.

Because the combination function 412 combines an up-sampled image 406 and its corresponding noisy up-sampled image 410 (rather than combining an up-sampled image 406 and pure noise) for input to the diffusion model 414, the diffusion model 414 is not using pure noise during the iterative process. The combination of the up-sampled image 406 and its corresponding noisy up-sampled image 410 still provides adequate noise so that the diffusion model 414 can operate. In addition, the combination of the up-sampled image 406 and its corresponding noisy up-sampled image 410 also provides a better starting point for the diffusion model 414 to de-noise the up-sampled image 406 and generate an output image 430. This is because the noisy up-sampled image 410 provides more useful information to the diffusion model 414 for use in generating better output images 430 compared to pure noise. Among other things, this approach helps to speed up the diffusion process and provide more stable results, such as output images 430 with little or no color or hue shifts.

One example of this approach is shown in FIG. 4, where an up-sampled image 406′ represents an up-scaled version of an input image 402. A noisy up-sampled image 410′ is produced using the degradation function 408, where the noisy up-sampled image 410′ is not pure noise but instead includes significant noise plus some image data from the up-sampled image 406′. As a result, the noisy up-sampled image 410′ can provide guidance to the diffusion model 414 during generation of a corresponding output image 430′.

Note that while FIG. 4 describes the use of the degradation function 408 in order to generate a noisy up-sampled image 410′ (rather than pure noise) for use during diffusion to support super-resolution, the same or similar techniques may be used for other image processing functions. For instance, the described techniques may be used to support any other inference sampling process to speed up and improve its performance, such as in terms of computation time and/or image quality. Also note that the diffusion model 414 may be trained and deployed in any suitable manner. For example, the diffusion model 414 may be trained by one device (such as the server 106) and used by the same device during inferencing (such as to process images obtained from electronic devices like the electronic device 101). As another example, the diffusion model 414 may be trained by one device (such as the server 106) and deployed to one or more other devices (such as the electronic device 101) for use during inferencing.

Although FIG. 4 illustrates one example of an architecture 400 supporting fast inferencing for high-quality super-resolution or other image processing using a diffusion model, various changes may be made to FIG. 4. For example, various components or functions in FIG. 4 may be combined, further subdivided, replicated, omitted, or rearranged and additional components or functions may be added according to particular needs.

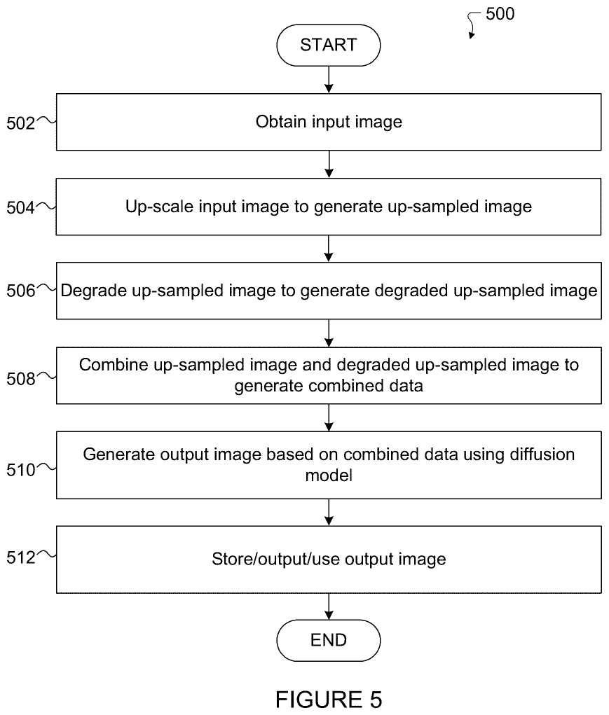

FIG. 5 illustrates an example method 500 for fast inferencing for high-quality super-resolution or other image processing using a diffusion model in accordance with this disclosure. For ease of explanation, the method 500 shown in FIG. 5 is described as being performed by the electronic device 101 in the network configuration 100 of FIG. 1, where the electronic device 101 supports the architecture 400 shown in FIG. 4. However, the method 500 shown in FIG. 5 could be performed using any other suitable device(s) and architecture(s) and in any other suitable system(s).

As shown in FIG. 5, an input image is obtained at step 502. This may include, for example, the processor 120 of the electronic device 101 obtaining an input image 402, which may be captured using at least one camera or other imaging sensor 180 of the electronic device 101, obtained over the Internet or other network via at least one communication interface 170 of the electronic device 101, or obtained in any other suitable manner. Up-scaling of the input image is performed to generate an up-sampled image at step 504. This may include, for example, the processor 120 of the electronic device 101 performing the up-scaling function 404 to increase the resolution of the image data contained in the input image 402 and generate an up-sampled image 406.

The up-sampled image is degraded in order to generate a degraded up-sampled image at step 506. This may include, for example, the processor 120 of the electronic device 101 performing the degradation function 408 to degrade the up-sampled image 406 and generate a noisy up-sampled image 410. In some embodiments, the processor 120 of the electronic device 101 may perform the forward diffusion process 200 in order to add noise to the up-sampled image 406 and generate the noisy up-sampled image 410. However, the processor 120 of the electronic device 101 can perform less than all of the iterations of the forward diffusion process 200 normally needed to convert an image into substantially pure noise. As a particular example, the processor 120 of the electronic device 101 can perform between 75% and 95% of the number of iterations of the forward diffusion process 200 that would otherwise be needed to convert an image into substantially pure noise. As a result, the noisy up-sampled image 410 includes both substantial noise and some portion of the image data from the up-sampled image 406.

The up-sampled image and the degraded up-sampled image are combined to generate combined data at step 508. This may include, for example, the processor 120 of the electronic device 101 performing the combination function 412 to combine the up-sampled image 406 and the noisy up-sampled image 410. The image data of these images may be combined in any suitable manner, such as concatenation or addition. An output image is generated based on the combined data at step 510. This may include, for example, the processor 120 of the electronic device 101 processing the up-sampled image 406 and the combination of the up-sampled image 406 and the noisy up-sampled image 410 using the diffusion model 414. The diffusion model 414 may be used in an iterative process in which progressively less-noisy images 426 are generated and fed back for further processing by the diffusion model 414.

The output image is stored, output, or used in some manner at step 512. This may include, for example, the processor 120 of the electronic device 101 initiating presentation of the output image 430 on a display 160 of the electronic device 101 or on the display of another device, storing the output image 430 in the memory 130 of the electronic device 101 or in the memory of another device, or using the output image 430 in any other suitable manner. In general, this disclosure is not limited to any particular use of the output image 430.

Although FIG. 5 illustrates one example of a method 500 for fast inferencing for high-quality super-resolution or other image processing using a diffusion model, various changes may be made to FIG. 5. For example, while shown as a series of steps, various steps in FIG. 5 may overlap, occur in parallel, occur in a different order, or occur any number of times (including zero times). As a particular example, the method 500 may be repeated any number of times to process and increase the resolution of any number of input images 402. Also, the method 500 may be adapted to support image processing functions other than super-resolution.

It should be noted that the functions shown in or described with respect to FIGS. 2 through 5 can be implemented in an electronic device 101, 102, 104, server 106, or other device(s) in any suitable manner. For example, in some embodiments, at least some of the functions shown in or described with respect to FIGS. 2 through 5 can be implemented or supported using one or more software applications or other software instructions that are executed by the processor 120 of the electronic device 101, 102, 104, server 106, or other device(s). In other embodiments, at least some of the functions shown in or described with respect to FIGS. 2 through 5 can be implemented or supported using dedicated hardware components. In general, the functions shown in or described with respect to FIGS. 2 through 5 can be performed using any suitable hardware or any suitable combination of hardware and software/firmware instructions. Also, the functions shown in or described with respect to FIGS. 2 through 5 can be performed by a single device or by multiple devices.

Although this disclosure has been described with example embodiments, various changes and modifications may be suggested to one skilled in the art. It is intended that this disclosure encompass such changes and modifications as fall within the scope of the appended claims.

What is claimed is:

1. A method comprising:
obtaining, using at least one processing device of an electronic device, an input image;
up-scaling, using the at least one processing device, the input image to generate an up-sampled image;
degrading, using the at least one processing device, the up-sampled image to generate a degraded up-sampled image;
combining, using the at least one processing device, the up-sampled image and the degraded up-sampled image to generate combined data; and
generating, using the at least one processing device, an output image based on the combined data, the output image generated using a diffusion model.

2. The method of claim 1, wherein degrading the up-sampled image comprises:
applying a forward diffusion process to the up-sampled image.

3. The method of claim 2, wherein:
the forward diffusion process is capable of converting an image into substantially pure noise if at least a specified number of iterations are performed; and
applying the forward diffusion process to the up-sampled image comprises performing less than the specified number of iterations using the up-sampled image in order to degrade the up-sampled image without converting the up-sampled image into pure noise.

4. The method of claim 3, wherein performing less than the specified number of iterations comprises performing between 75% and 95% of the specified number of iterations.

5. The method of claim 1, wherein combining the up-sampled image and the degraded up-sampled image comprises performing at least one of a concatenation or an addition of the up-sampled image and the degraded up-sampled image.

6. The method of claim 1, wherein degrading the up-sampled image comprises adding Gaussian noise to the up-sampled image.

7. The method of claim 1, wherein the output image represents a super-resolution version of the input image.

8. An electronic device comprising:
at least one processing device configured to:
obtain an input image;
up-scale the input image to generate an up-sampled image;
degrade the up-sampled image to generate a degraded up-sampled image;
combine the up-sampled image and the degraded up-sampled image to generate combined data; and
generate an output image based on the combined data, wherein the at least one processing device is configured to generate the output image using a diffusion model.

9. The electronic device of claim 8, wherein, to degrade the up-sampled image, the at least one processing device is configured to apply a forward diffusion process to the up-sampled image.

10. The electronic device of claim 9, wherein:
the forward diffusion process is capable of converting an image into substantially pure noise if at least a specified number of iterations are performed; and
to apply the forward diffusion process to the up-sampled image, the at least one processing device is configured to perform less than the specified number of iterations using the up-sampled image in order to degrade the up-sampled image without converting the up-sampled image into pure noise.

11. The electronic device of claim 10, wherein, to perform less than the specified number of iterations, the at least one processing device is configured to perform between 75% and 95% of the specified number of iterations.

12. The electronic device of claim 8, wherein, to combine the up-sampled image and the degraded up-sampled image, the at least one processing device is configured to perform at least one of a concatenation or an addition of the up-sampled image and the degraded up-sampled image.

13. The electronic device of claim 8, wherein, to degrade the up-sampled image, the at least one processing device is configured to add Gaussian noise to the up-sampled image.

14. The electronic device of claim 8, wherein the output image represents a super-resolution version of the input image.

15. A non-transitory machine readable medium containing instructions that when executed cause at least one processor of an electronic device to:
obtain an input image;
up-scale the input image to generate an up-sampled image;
degrade the up-sampled image to generate a degraded up-sampled image;
combine the up-sampled image and the degraded up-sampled image to generate combined data; and
generate an output image based on the combined data, wherein the instructions when executed cause the at least one processor to generate the output image using a diffusion model.

16. The non-transitory machine readable medium of claim 15, wherein the instructions that when executed cause the at least one processor to degrade the up-sampled image comprise:
instructions that when executed cause the at least one processor to apply a forward diffusion process to the up-sampled image.

17. The non-transitory machine readable medium of claim 16, wherein:
the forward diffusion process is capable of converting an image into substantially pure noise if at least a specified number of iterations are performed; and
the instructions that when executed cause the at least one processor to apply the forward diffusion process to the up-sampled image comprise:
instructions that when executed cause the at least one processor to perform less than the specified number of iterations using the up-sampled image in order to degrade the up-sampled image without converting the up-sampled image into pure noise.

18. The non-transitory machine readable medium of claim 17, wherein the instructions that when executed cause the at least one processor to perform less than the specified number of iterations comprise:
instructions that when executed cause the at least one processor to perform between 75% and 95% of the specified number of iterations.

19. The non-transitory machine readable medium of claim 15, wherein the instructions that when executed cause the at least one processor to combine the up-sampled image and the degraded up-sampled image comprise:
instructions that when executed cause the at least one processor to perform at least one of a concatenation or an addition of the up-sampled image and the degraded up-sampled image.

20. The non-transitory machine readable medium of claim 15, wherein the instructions that when executed cause the at least one processor to degrade the up-sampled image comprise:
instructions that when executed cause the at least one processor to add Gaussian noise to the up-sampled image.
